(19) United States
(12) Patent Application Publication
(10) Pub. No.: US 2014/0184783 A1
(43) Pub. Date: Jul. 3, 2014

(54) DEVICE FOR DETERMINING SURFACE DEFECTS

(71) Applicant: HON HAI PRECISION INDUSTRY CO., LTD., New Taipei (TW)

(72) Inventors: Hou-Hsien LEE, New Taipei (TW); Chang-Jung LEE, New Taipei (TW); Chih-Ping LO, New Taipei (TW)

(73) Assignee: HON HAI PRECISION INDUSTRY CO., LTD., New Taipei (TW)

(21) Appl. No.: 14/097,254

(22) Filed: Dec. 5, 2013

(30) Foreign Application Priority Data
Dec. 27, 2012 (TW) 101150706

(51) Int. Cl. G06T 7/00; H04N 7/18

(52) U.S. Cl. CPC G06T 7/0008; H04N 7/18
USPC 348/92

(57) ABSTRACT

A device for determining the surface defects of a product includes a base, a support member, a platform, a lighting unit, an image capturing unit, and a processing unit. The lighting unit includes a driving unit, a frame and a number of light sources. The light sources are mounted along the frame. The driving unit drives the frame to move in six degrees of freedom, the light sources emitting light to illuminate the product in different directions. The image capturing unit captures images of the product on the base. The captured images of the product are analyzed and matched against similar views of a blemish-free model product, any discrepancies leading to a determination that the product has any surface defects.

### CROSS-REFERENCE TO RELATED APPLICATION

This application is related to a co-pending application, entitled “DEVICE FOR DETERMINING SURFACE DEFECTS,” filed **** (Atty. Docket No. US49259).

### BACKGROUND

1. Technical Field

The present disclosure relates to devices and, more particularly, to a device for determining whether or not a product has surface defects.

2. Description of Related Art

Quality control is an important aspect of mass production. For many products, determining whether or not a product has any surface defects, such as a scratch or smudge, is necessary. When detecting the surface defects, an image capturing unit is usually employed to capture images of the product to determine the defects, and a light source is employed to illuminate the product to increase the quality of the image. However, the light source emits light in only narrow directions, some defects of the product may be difficult to find.

Therefore, what is needed is a device to resolve the issues described above.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding units throughout the several views.

FIG. 1 is an isometric view of a device for determining surface defect, in accordance with an exemplary embodiment.

FIG. 2 is an isometric view of the device of FIG. 1 in a working state.

FIG. 3 is a schematic block diagram of the device of FIG. 1.

### DETAILED DESCRIPTION

Embodiments of the present disclosure are described with reference to the accompanying drawings.

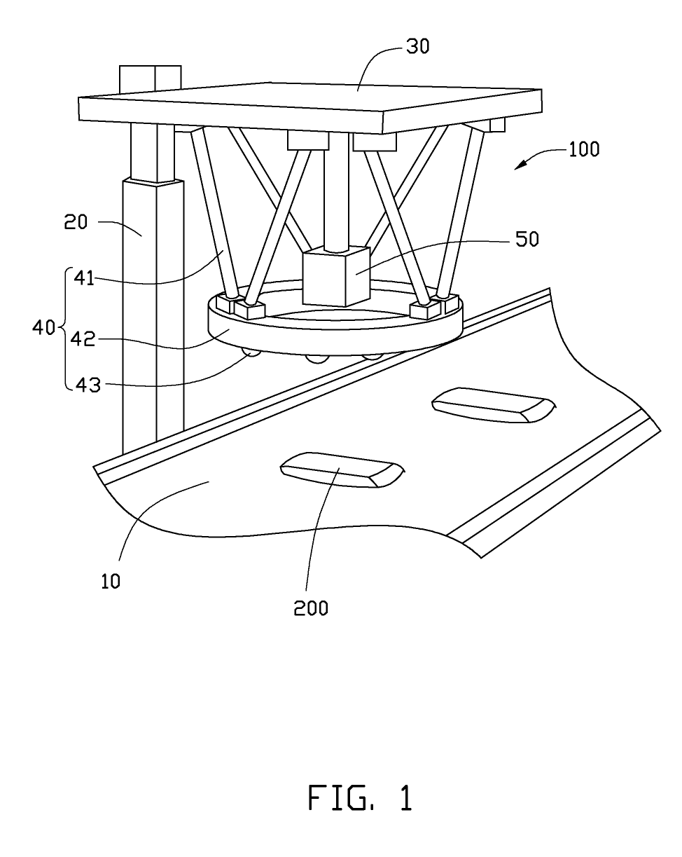

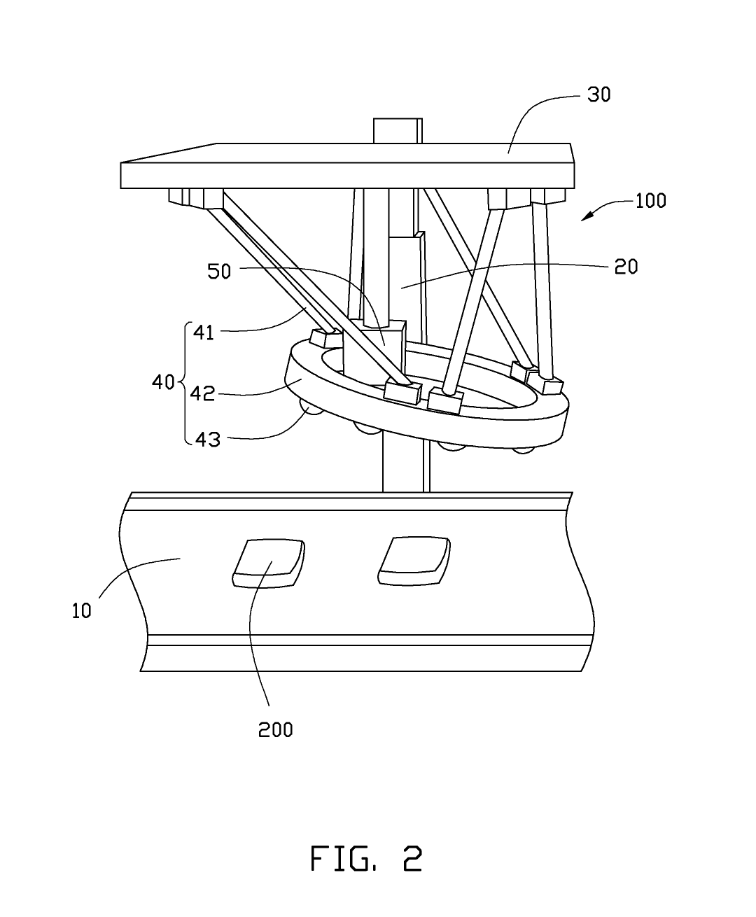

FIGS. 1-3 show an exemplary embodiment of a device 100 for determining whether or not a product 200 has any surface defects (e.g., a scratch or other non-uniformity). The device 100 includes a base 10, a support member 20, a platform 30, a lighting unit 40, an image capturing unit 50, and a processing unit 60.

The base 10 is configured to support the product 200. In this embodiment, the base 10 is a conveyer.

The support member 20 is perpendicular to the base 10 and connected to the base 10 at a bottom end portion.

The platform 30 is perpendicularly connected to the top end of the support member 20, facing the base 10.

The lighting unit 40 is connected to the platform 30, and faces the base 10 to light the product 200 placed on the base 10. The lighting unit 40 includes a driving unit 41, a frame 42, and a number of light sources 43 (e.g., LEDs). In this embodiment, the driving unit 41 includes a number of six prismatic actuators mounted in pairs to the frame 42 and crossing over to three mounting points on the platform 30. Then, the platform 30, the driving unit 22, and the frame 42 cooperatively form a STEWART platform, thereby allowing the frame 42 to move in six degrees of freedom.

The light sources 43 are arranged along the frame 43 and face the base 10. The light sources 43 move along with the frame 43, and illuminate the product 200 in different directions when the frame 43 moves in six degrees of freedom. Thus, the defects on the product 200 can be found. In this embodiment, the frame 43 is annular. In other embodiments, the frame 43 may be polygonal. In this embodiment, a mechanical switch (not shown) is used to turn on or off the light sources 43.

The image capturing unit 50 is connected to the platform 30 and faces the base 10 for capturing images of the product 200. The light sources 43 emit light to provide sufficient light for the image capturing unit 50 in different directions to make sure that the image capturing unit 50 can capture high quality images of the product 200.

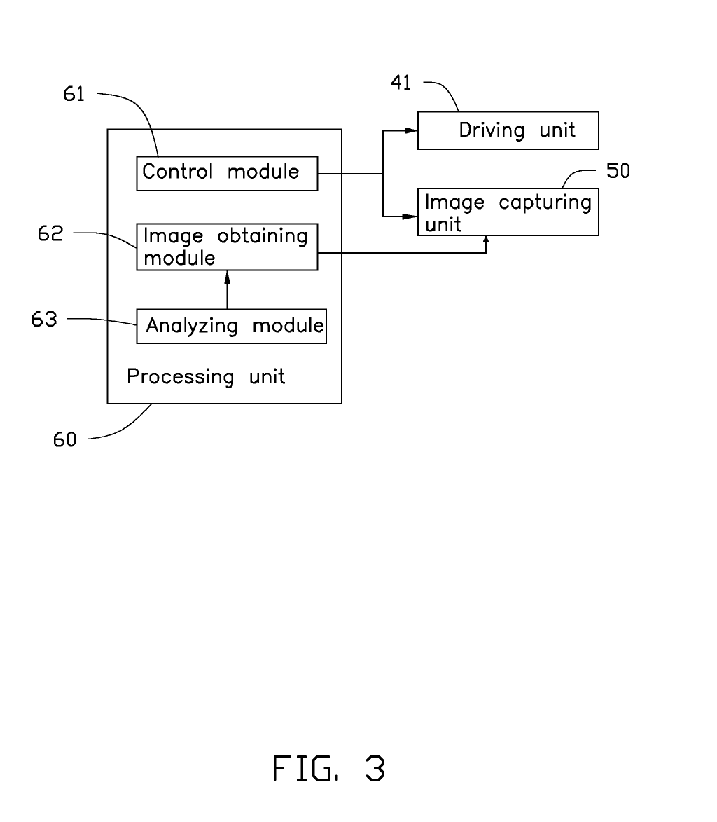

Referring to FIG. 3, the processing unit 60 is arranged inside the base 10 or the support member 20. The processing unit 60 includes a control module 61, an image obtaining module 62, and an analyzing module 63, which are a collection of instructions and executed by the processing unit 60.

The control module 61 communicates with the driving unit 41 and controls the driving unit 41 to drive the frame 42 to move in six degrees of freedom. The control module 61 further controls the image capturing unit 50 to capture images of the product 200 when the light sources 43 move in six degrees of freedom along with the frame 42 and illuminate the product 200 in different directions. In this embodiment, the control module 61 controls the driving unit 41 to drive the frame 42 according to stored parameters. In an implementation, the stored parameters include the total number of times that the frame is driven to move in six degrees of freedom by the driving unit 41, and the time interval between each two times that the frame 41 is driven to move in six degrees of freedom. In the illustrated embodiment, the stored parameters are preset by a user via a peripheral input device (not shown), such as a keyboard.

The image obtaining module 62 obtains the captured images of the product 200.

The analyzing module 63 determines whether or not the product 200 has any surface defects according to the obtained images. In the embodiment, the analyzing module 63 compares the obtained images with a stored image of a standard product. If each obtained image of the product matches the stored image of the standard product, the analyzing module 63 determines that the product 200 has no surface defect. In an alternative embodiment, the analyzing module 63 may employ a Fourier transform to the obtained images to obtain a number of frequency spectrograms, and determine whether or not the product 200 has a surface defect according to the obtained frequency spectrograms. The technology of determining surface defects on a product according to the frequency spectrograms is known in the art, such as the subject matter of U.S. Patent Application Patent No. 007069154, which is herein incorporated by reference.

In the embodiment, the processing unit 60 further includes an outputting module 64, and the outputting module 64 outputs the result of determination by the analyzing module 63 to an electronic device (not shown). In the illustrated embodiment, the output determining result of the analyzing module 63 can be an audio file or a text message.

In an alternative embodiment, the processing unit 60 may be applied in a peripheral device (e.g., a computer) which communicates with the device 100 via a wireless or a wired access interface

Although the present disclosure has been specifically described on the basis of the exemplary embodiments thereof, the disclosure is not to be construed as being limited thereto.

Various changes or modifications may be made to the embodiments without departing from the scope and spirit of the disclosure.

What is claimed is:

1. A device for determining whether or not a product has surface defects, the device comprising:
a base to support the product;
a support member connected to the base;
a platform connected to the support member and facing the base;
a lighting unit comprising a driving unit, a frame and a plurality of light sources, the plurality of light sources being mounted along the frame, the driving unit comprising six prismatic actuators mounted in pairs to the frame and crossing over to the three mounting points on the platform, and the platform, the driving unit, and the frame cooperatively forming a STEWART platform, thereby allowing the frame and the light sources to move in six degrees of freedom, the light sources emitting light to illuminate the product in different directions;
an image capturing unit connected to the platform and facing the base to capture images of the product when the light sources moves in six degrees of freedom; and
a processing unit comprising:
a control module to control the driving unit to drive the frame to move in six degrees of freedom, and further control the image capturing unit to capture images of the product when the light sources moves in six degrees of freedom;
an image obtaining module to obtain the captured images of the product; and
an analyzing module to determine whether or not the product has any surface defects according to the obtained images.

2. The device as described in claim 1, wherein the control module controls the driving unit to drive the main body according to a plurality of stored parameters, and the stored parameters comprise total number of times that the frame is driven to move in six degrees of freedom by the driving unit, and a time interval between each two times that the frame moves in six degrees of freedom.

3. The device as described in claim 1, wherein the analyzing module compares the obtained images with a stored image of a standard product, and if each obtained image of the product matches the stored image of the standard product, the analyzing module determines that the product has no surface defect.

4. The device as described in claim 1, wherein the analyzing module may employ a Fourier transform to the obtained images to obtain a number of frequency spectrograms, and determine whether or not the product has a surface defect according to the obtained frequency spectrograms.

5. The device as described in claim 1, wherein the frame is annular.

6. The device as described in claim 1, wherein the frame is polygonal.
